(19) United States
(12) Patent Application Publication
(10) Pub. No.: US 2017/0028746 A1
(43) Pub. Date: Feb. 2, 2017

(54) PRINTER

(71) Applicants: Qisda Optronics (Suzhou) Co., Ltd., Suzhou (CN); Qisda Corporation, Taoyuan (TW)

(72) Inventors: CHING-CHUAN CHEN, New Taipei (TW); HUAI-WEN HSU, Taipei (TW)

(21) Appl. No.: 15/190,173

(22) Filed: Jun. 23, 2016

(30) Foreign Application Priority Data
Jul. 31, 2015 (CN) 201510464956.1

(51) Int. Cl. B41J 11/04

(52) U.S. Cl. CPC B41J 11/04; B41J 2/32

(57) ABSTRACT

A printer includes a base, a cover, a feeding roller, a support member, a rotating member and a driving member. The cover is pivotally connected to the base. The feeding roller includes an axle pivotally connected to the cover. The support member is disposed on the base. The rotating member is pivotally connected to the support member and includes an engaging portion and a pushing portion. The driving member is disposed corresponding to the rotating member. When the cover is closed with respect to the base, the feeding roller abuts against the rotating member and the axle is engaged with the engaging portion. When the driving member drives the rotating member to rotate, the axle is released from the engaging portion and the pushing portion pushes against the cover so that the cover is opened with respect to the base.

### BACKGROUND OF THE INVENTION

1. Field of the Invention

The present invention relates to a printer, and more particularly, to a printer with simple mechanism for opening and closing the cover with respect to the base.

2. Description of the Prior Art

Thermal printers have been extensively used in printing purchase receipts at various points of sales, such as retailers, financial services, hotels and medical services, etc. A thermal printer typically includes a base and a cover pivotally connected to the base, and a paper roll is disposed in the space between the base and the cover. For the user to replace a new paper roll in time when the original paper roll is used up, an additional mechanism disposed outside the cover of the thermal printer has been utilized for lifting the cover in the prior art. The mechanism for lifting the cover, however, involves lots of components and requires complicated operation, resulting in increased costs and poor operability.

### SUMMARY OF THE INVENTION

One of the purposes of the present invention is to provide a printer with simple mechanism for opening and closing the cover with respect to the base to solve the aforementioned problems.

According to one embodiment of the present invention, the printer includes a base, a cover, a feeding roller, a support member, a rotating member and a driving member. The cover is pivotally connected to the base. The feeding roller includes an axle pivotally connected to the cover. The support member is disposed on the base. The rotating member is pivotally connected to the support member and includes an engaging portion and a pushing portion. The driving member is disposed corresponding to the rotating member. When the cover is closed with respect to the base, the feeding roller abuts against the rotating member and the axle is engaged with the engaging portion. When the driving member drives the rotating member to rotate, the axle is released from the engaging portion and the pushing portion pushes against the cover so that the cover is opened with respect to the base.

In sum, when the cover is closed with respect to the base, the axle of the feeding roller is engaged with the engaging portion of the rotating member so that the cover is fixed at its closed position. When the user desires to open the cover with respect to the base, the user operates the driving member to drive the rotating member to rotate. At this time, the axle of the feeding roller is released from the engaging portion of the rotating member, and the pushing portion of the rotating member pushes against the cover so that the cover is opened with respect to the base. Thus, the present invention simplifies the operation of the printer and saves production costs of the printer by effectively reducing the number of required components.

The above-mentioned and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a three dimensional view of a printer according to an embodiment of the present invention;

FIG. 2 is a schematic view of the interior of the printer of FIG. 1;

FIG. 3 is a partial exploded view of the printer of FIG. 2;

FIG. 4 is a schematic view of the printer of FIG. 3 from another viewing angle;

FIG. 5 is a top view of the printer of FIG. 2;

FIG. 6 is a cross-sectional view of the printer of FIG. 5 along line X-X;

FIG. 7 is a cross-sectional view of the printer of FIG. 5 along line Y-Y;

FIG. 8 is a schematic view of the axle being released from the engaging portion of FIG. 6;

FIG. 9 is a schematic view of the cover being opened with respect to the base of FIG. 8;

FIG. 10 is a cross-sectional view of a printer according to another embodiment of the present invention; and

FIG. 11 is a cross-sectional view of a printer according to yet another embodiment of the present invention.

### DETAILED DESCRIPTION OF PREFERRED EMBODIMENTS

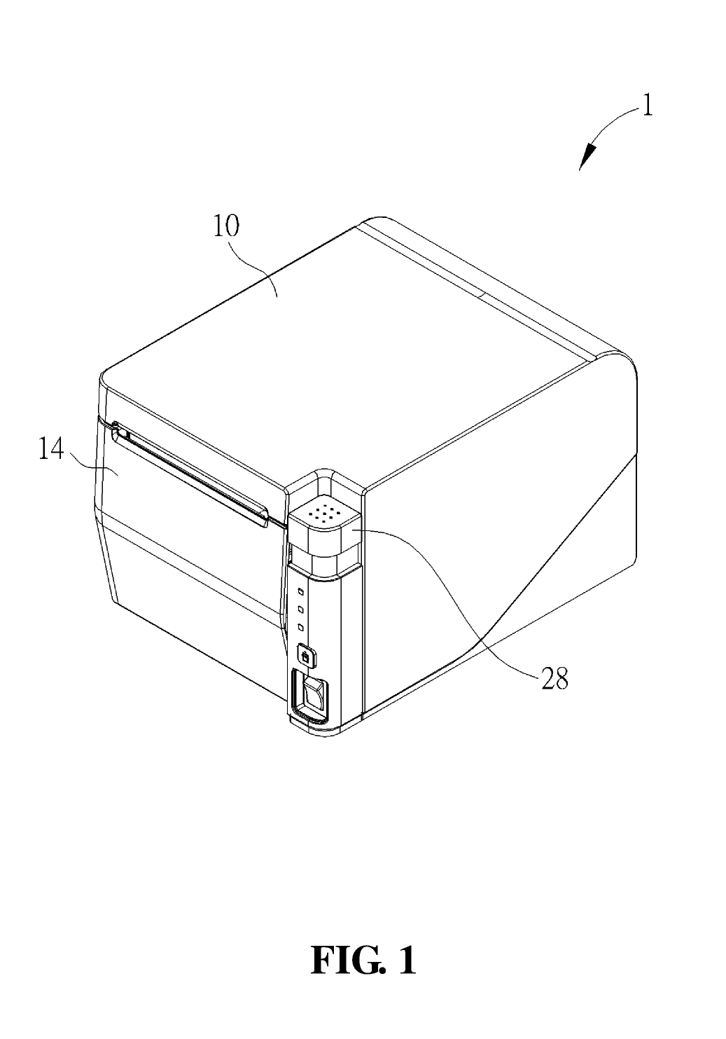

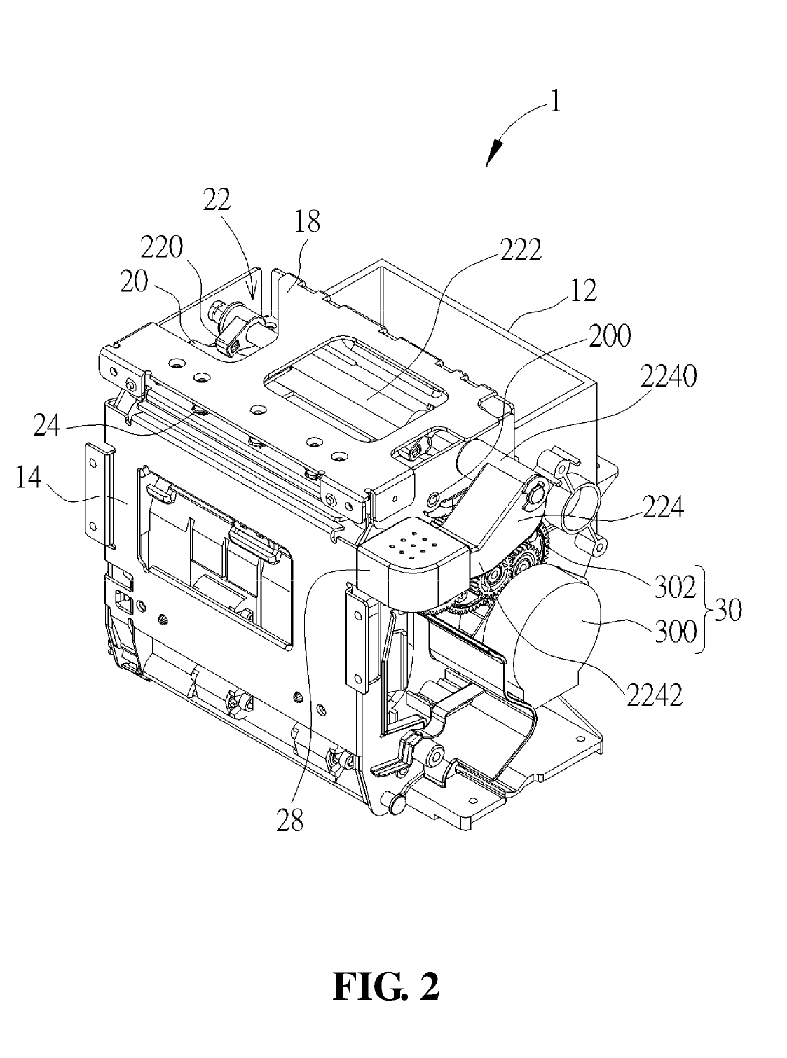

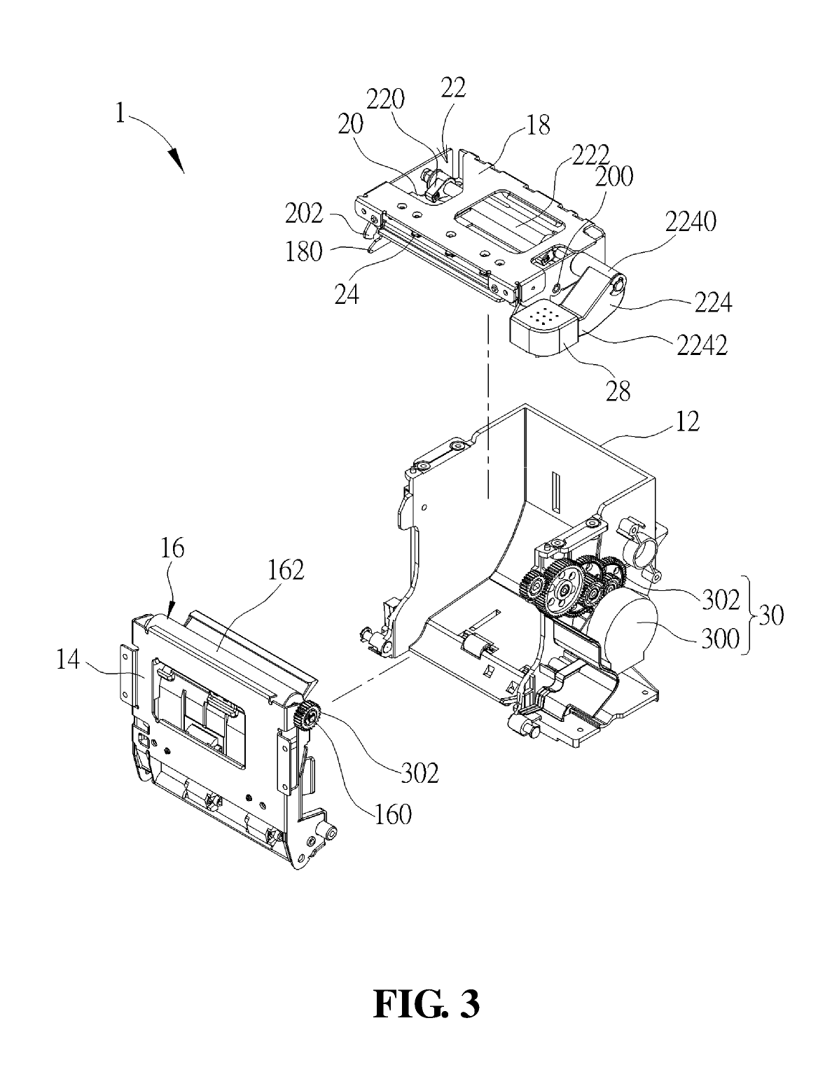

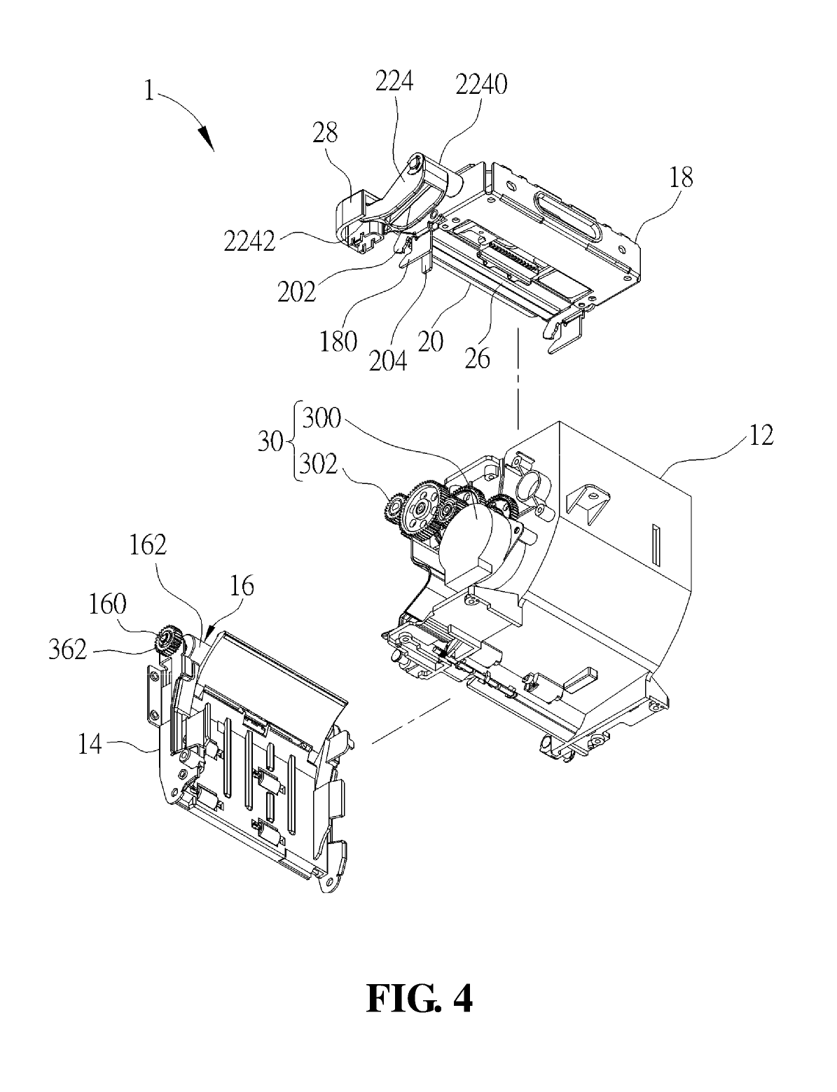

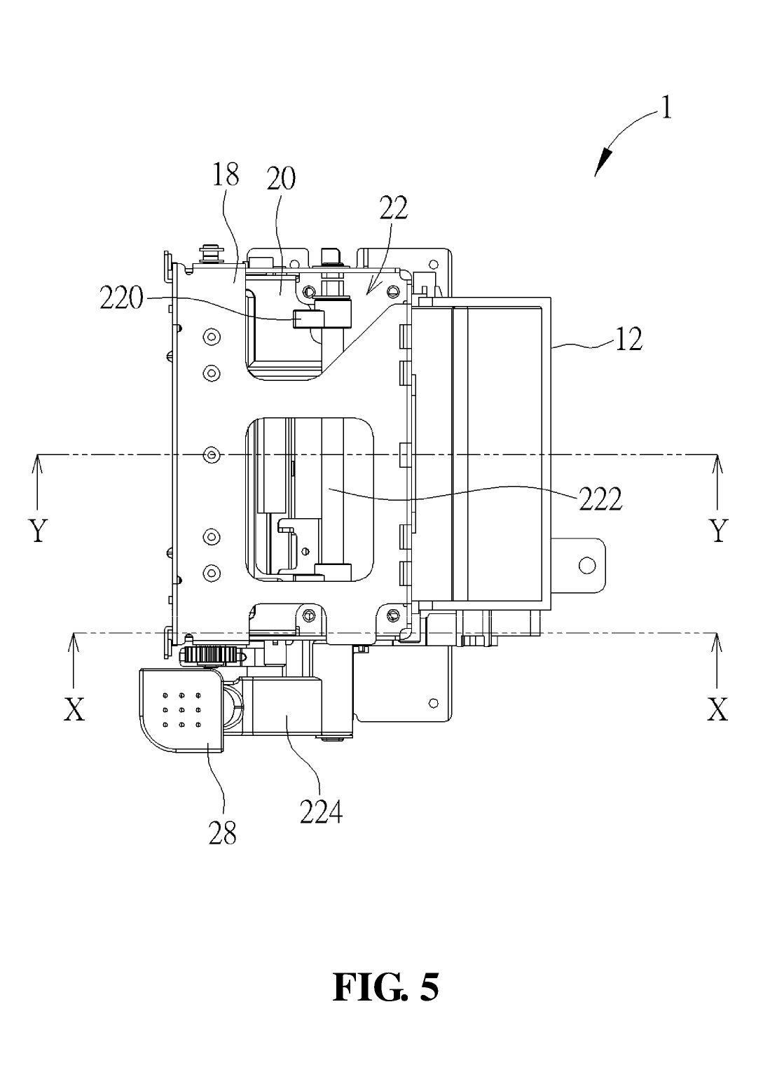

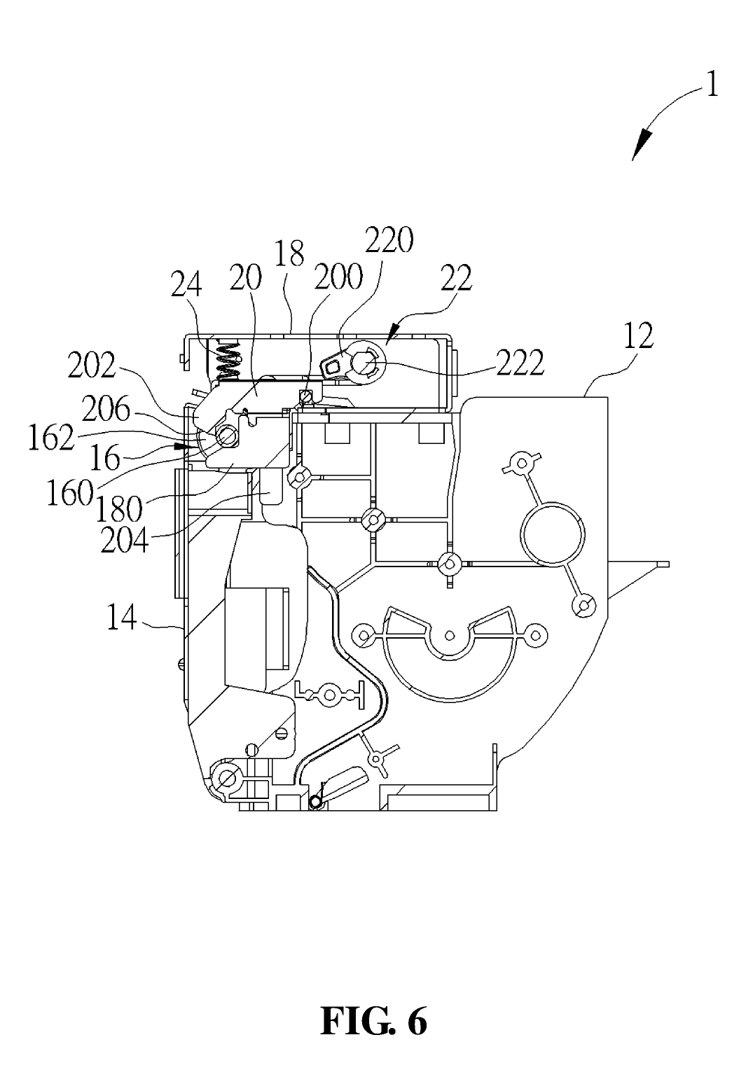

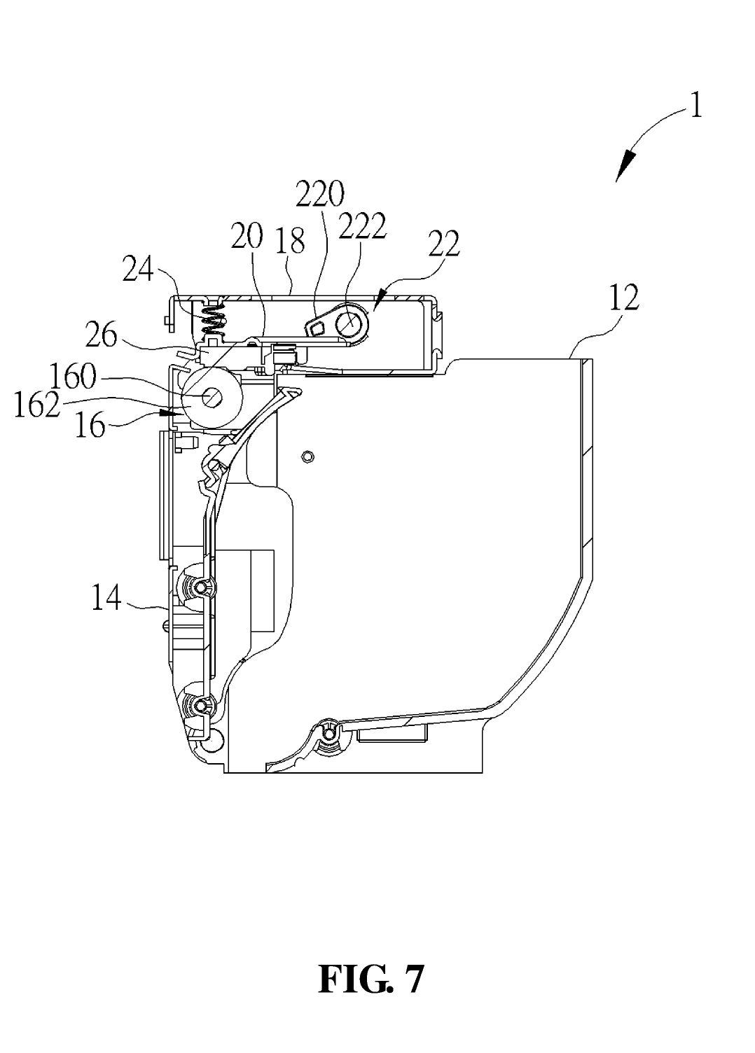

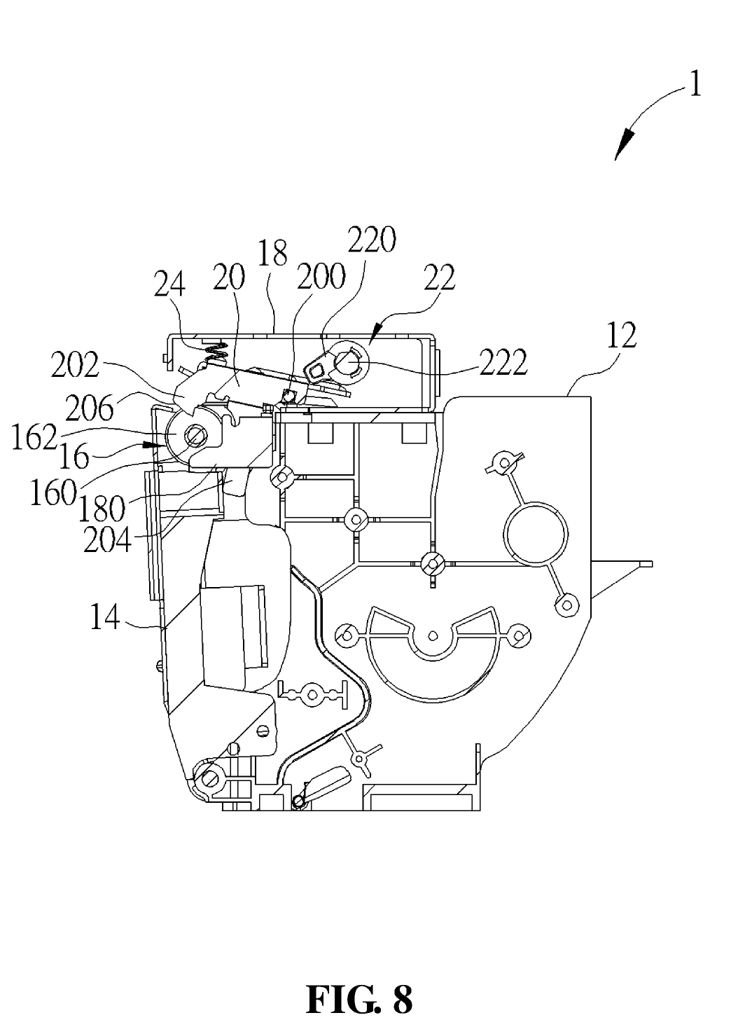

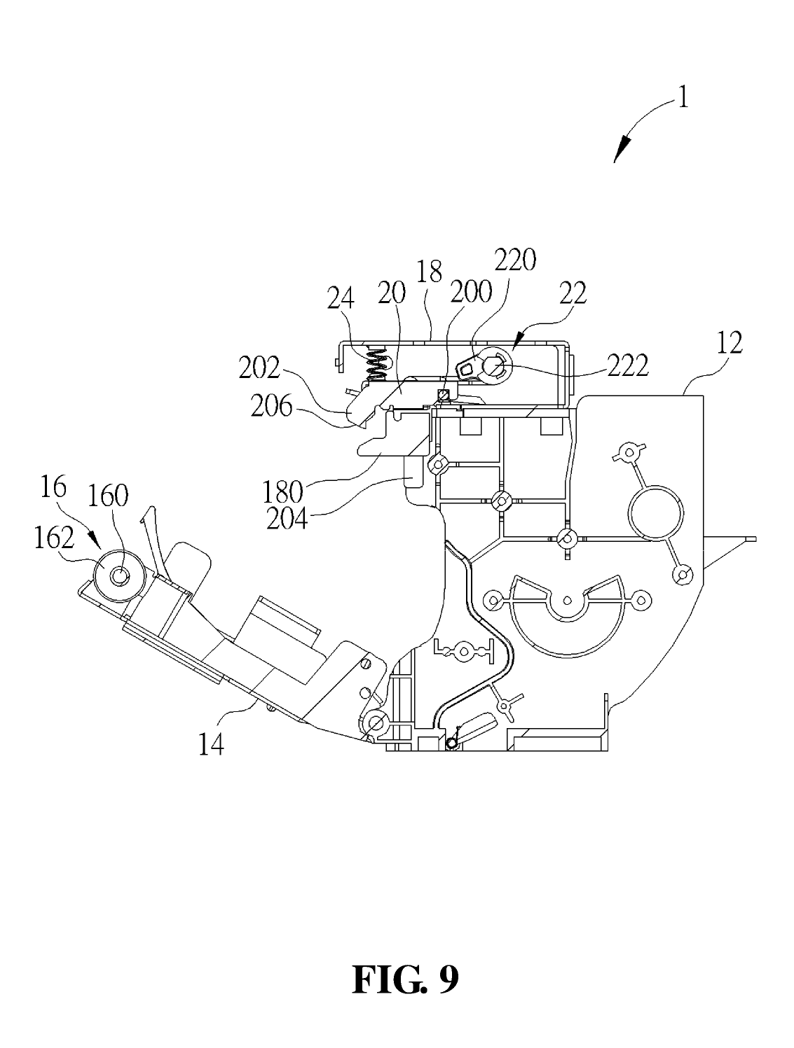

Please refer to FIG. 1 through FIG. 9. FIG. 1 is a three dimensional view of the printer 1 according to an embodiment of the present invention. FIG. 2 is a schematic view of the interior of the printer 1 of FIG. 1. FIG. 3 is a partial exploded view of the printer 1 of FIG. 2. FIG. 4 is a schematic view of the printer 1 of FIG. 3 from another viewing angle. FIG. 5 is a top view of the printer 1 of FIG. 2. FIG. 6 is a cross-sectional view of the printer 1 of FIG. 5 along line X-X. FIG. 7 is a cross-sectional view of the printer 1 of FIG. 5 along line Y-Y. FIG. 8 is a schematic view of the axle 160 being released from the engaging portion 202 of FIG. 6. FIG. 9 is a schematic view of the cover 14 being opened with respect to the base 12 of FIG. 8.

As shown in FIG. 1 through FIG. 9, the printer 1 includes a casing 10, a base 12, a cover 14, a feeding roller 16, a support member 18, a rotating member 20, a driving member 22, an elastic member 24, a printing head 26, a button 28 and a driving module 30. In the embodiment of the present invention, the printer 1 may be a thermal printer, but is not so limited. In practical applications, the printer 1 could also include other hardware and/or software required for operation, such as printer circuit board, memory, power supply, application program, communication module and sensor, etc.

The base 12, the cover 14, the feeding roller 16, the support member 18, the rotating member 20, the driving member 22, the elastic member 24, the printing head 26 and the driving module 30 are all disposed in the casing 10. The button 28 is disposed on the casing 10 for the user to press. The cover 14 is pivotally connected to the base 12 so that the cover 14 may be opened or closed with respect to the base 12. A paper roll (not shown) is disposed in the space between the base 12 and the cover 14. The feeding roller 16 includes a axle 160 and an elastic wheel body 162. The axle 160 is pivotally connected to the cover 14, and the elastic wheel body 162 is disposed about the axle 160. In the embodiment, the elastic wheel body 162 is made of rubber or other elastic material. The support member 18 is disposed on the base 12. The rotating member 20 is pivotally connected to the support member 18 via the axle 200 so that the rotating member 20 may rotate with respect to the support member 18. Besides, the rotating member 20 includes a engaging portion 202 and a pushing portion 204.

The driving member 22 is disposed corresponding to the rotating member 20. In the embodiment. The driving member 22 includes a cam 220, a rod 222 and a linking portion 224. The rod 222 is pivotally connected to the support member 18. The linking portion 224 includes a fixed end 2240 and a free end 2242. The cam 220 and the fixed end 2240 of the linking portion 224 are fixed at two opposite ends of the rod 222. When the free end 2242 of the linking portion 224 is pressed, the linking portion 224 and the rod 222 drives the cam 220 to rotate counterclockwise so that the cam 220 drives the rotating member 20 to rotate clockwise from the viewing angle of FIG. 2 through FIG. 4 and FIG. 6 through FIG. 9. In the embodiment, two cams 220 are fixed on the rod 222. However, the number and location of the cam 220 can be determined according to practical demands and are not so limited.

In the embodiment, the button 28 is movably disposed on the casing 10 corresponding to the free end 2242 of the linking portion 224. Thus, when the button 28 is pressed, the button 28 drives the cam 220 to rotate counterclockwise via the linking portion 224 and the rod 222 so that the cam 220 drives the rotating member 20 to rotate clockwise. It is to be understood that in the present invention the free end 2242 of the linking portion 224 may be exposed outside the casing. Under such circumstance, the user can directly press the free end 2242 of the linking portion 224 without having to install an additional button 28.

The elastic member 24 is disposed between the support member 18 and the rotating member 20. In the embodiment, three elastic members 24 are disposed between the support member 18 and the rotating member 20. However, the number and location of the elastic member 24 can be determined according to practical demands and are not so limited. Moreover, the elastic members 24 may be a spring, but is not so limited. The driving module 30 is disposed on the base 12 and the feeding roller 16 is driven by the driving module 30 to rotate. The driving module 30 includes a motor 300 and a plurality of intermeshing gear wheels 302. One of the gear wheels 302 is coupled with the motor 300, and another of the gear wheels 302 is coupled with the axle 160 of the feeding roller 16 so that the feeding roller 16 rotates in respond to rotation of the plurality of gear wheels 302 driven by the motor 300.

As shown in FIG. 7, the printing head 26 is disposed on the rotating member 20 corresponding to the feeding roller 16. When the cover 14 is closed with respect to the base 12, the elastic force generated by the elastic member 24 causes the printing head 26 to abut against the feeding roller 16. In other words, when the cover 14 is closed with respect to the base 12, the elastic wheel body 162 of the feeding roller 16 receives a pre-compression force caused by abutting of the printing head and thus deforms. Besides, the support member 18 includes a limiting portion 180. As shown in FIG. 6, when the cover 14 is closed with respect to the base 12, the axle 160 of the feeding roller 16 is engaged between the engaging portion 202 of the rotating member 20 and the limiting portion 180 of the support member 18. Hence, when the cover 14 is closed with respect to the base 12, the printing head 26 would definitely abut against the feeding roller 16. Please note that if the printing head 26 is not disposed on the rotating member 20, the feeding roller 16 may alternatively abut against the rotating member 20 when the cover 14 is closed with respect to the base 12.

When the user desires to open the cover 14 with respect to the base 12, the user may press the button 28. When the button 28 is pressed, the button 28 drives the cam 220 to rotate via the linking portion 224 and the rod 222 so that the cam 220 drives the rotating member 20 to rotate. As shown in FIGS. 8 and 9, when the cam 220 of the driving member 22 drives the rotating member 20 to rotate, the rotating member 20 compresses the elastic member 24, the axle 160 of the feeding roller 16 is released from the engaging portion 202 of the rotating member 20, and the pushing portion 204 then pushes against the cover 14 so that the cover 14 is opened with respect to the base 12.

As described above, when the cover 14 is closed with respect to the base 12, the elastic wheel body 162 of the feeding roller 16 receives the pre-compression force caused by abutting of the printing head and thus deforms. Hence, when the cam 220 of the driving member 22 drives the rotating member 20 to rotate so that the axle 160 of the feeding roller 16 is released from the engaging portion 202 of the rotating member 20, the pre-compression force received by the elastic wheel body 162 of the feeding roller 16 is released, and the feeding roller 16 moves toward the direction away from the printing head 26 so that the cover 14 is opened with respect to the base 12. When the driving member 22 is released, the elastic force generated by the compressed elastic member 24 repositions the rotating member 20 as shown in FIG. 9.

In the embodiment, the rotating member 20 includes an inclined plane 206 facing the cover 14. When the cover 14 is opened with respect to the base 12, the user may push to let the cover 14 rotate toward the base 12 so that the cover 14 is closed with respect to the base 12. When the cover 14 receives the external force applied by the user to rotate toward the base 12, the axle 160 of the feeding roller 16 pushes against the inclined plane 206 of the rotating member 20 so that the rotating member 20 rotates clockwise with respect to the support member 18 from the viewing angle of FIG. 2 through FIG. 4 and FIG. 6 through FIG. 9. The axle 160 of the feeding roller 16 is subsequently engaged with the engaging portion 202 of the rotating member 20, and the printing head 26 disposed on the rotating member 20 abuts against the feeding roller 16. Consequently, the cover 14 is closed with respect to the base 12.

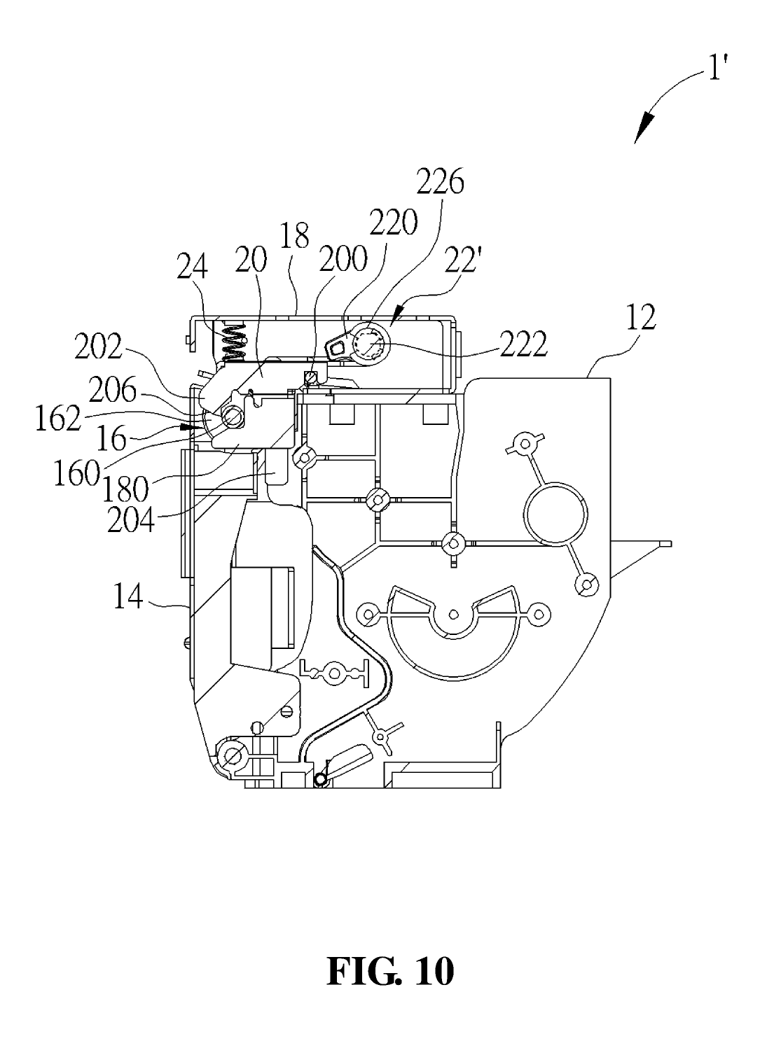

Please refer to FIG. 10. FIG. 10 is a cross-sectional view of a printer 1′ according to another embodiment of the present invention. The printer 1′ and the aforementioned printer 1 differ in that the driving member 22′ of the printer 1′ include a cam 220, a rod 222 and a knob 226 as shown in FIG. 10. The rod 222 is pivotally connected to the support member 18, and the cam 220 and the knob 226 are fixed at two opposite ends of the rod 222. In the embodiment, the knob 226 may be exposed outside the casing 10 for the user to rotate. When the knob 226 is rotated counterclockwise, the knob 226 drives the cam 220 to rotate counterclockwise via the rod 222 so that the cam 220 drives the rotating member 20 to rotate clockwise from the viewing angle of FIG. 10. In other words, the driving member 22′ of the printer 1′ is implemented by the knob 226 instead of the linking portion 224 of the driving member 22 of the printer 1, and installation of the aforementioned button 28 is not required. Please note that the components shown in FIG. 10 with the same numberings as those shown in FIG. 1 through FIG. 9 operate in substantially the same way and are not repeatedly described in details herein.

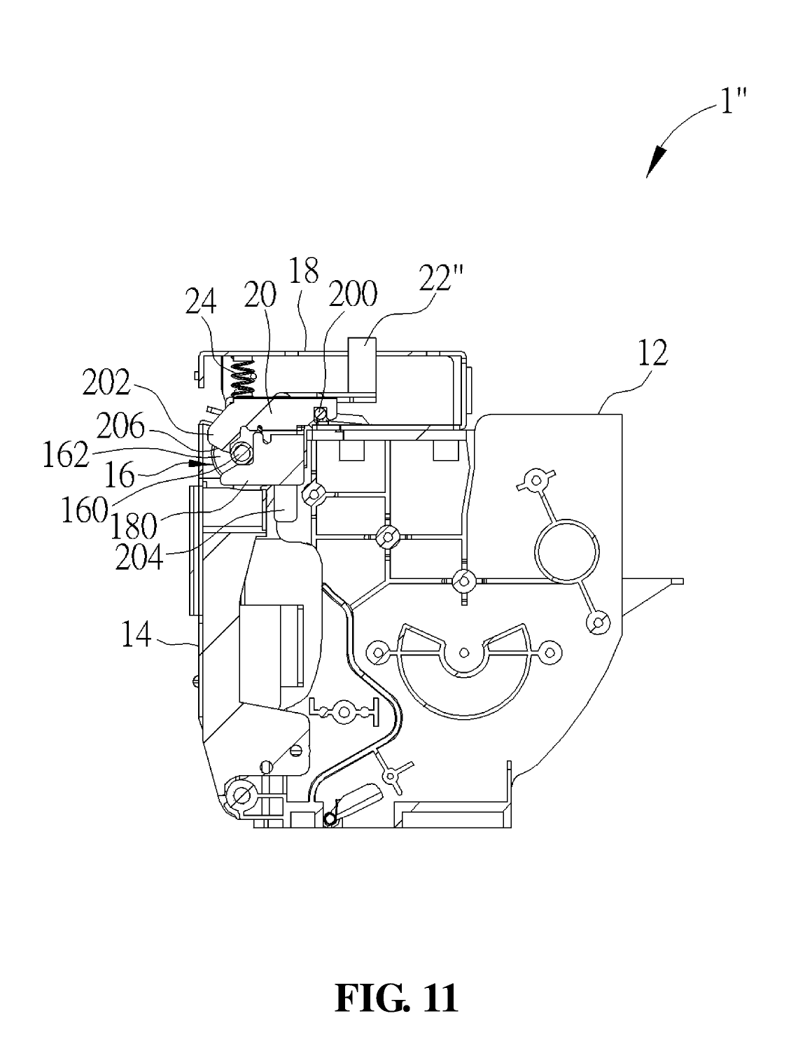

Please refer to FIG. 11. FIG. 11 is a cross-sectional view of a printer 1″ according to yet another embodiment of the present invention. The printer 1″ and the aforementioned printer 1 differ in that the driving member 22″ of the printer 1″ is a button as shown in FIG. 11. In the embodiment, the driving member 22″ may be exposed outside the casing 10 shown in FIG. 1 for the user to press. When the driving member 22″ is pressed, the driving member 22″ directly drives the rotating member 20 to rotate clockwise from the viewing angle of FIG. 11. In other words, the driving member 22″ of the printer 1″ is implemented by the button instead of the driving member 22 of the aforementioned printer 1. Please note that the components shown in FIG. 11 with the same numberings as those shown in FIG. 1 through FIG. 9 operate in substantially the same way and are not repeatedly described in details herein.

In sum, according to the aforementioned embodiments of the present invention, when the cover is closed with respect to the base, the axle of the feeding roller is engaged with the engaging portion of the rotating member so that the cover is fixed at its closed position. When the user desires to open the cover with respect to the base, the user may trigger the driving member to drive the rotating member to rotate. At this time, the axle of the feeding roller is released from the engaging portion of the rotating member, and the pushing portion of the rotating member pushes against the cover so that the cover is opened with respect to the base. Thus, the present invention simplifies the operation of the printer and saves production costs of the printer by effectively reducing the number of required components.

Those skilled in the art will readily observe that numerous modifications and alterations of the device and method may be made while retaining the teachings of the invention.

What is claimed is:

1. A printer comprising:
a base;
a cover pivotally connected to the base;
a feeding roller having an axle pivotally connected to the cover;
a support member disposed on the base;
a rotating member pivotally connected to the support member, the rotating member having an engaging portion and a pushing portion; and
a driving member disposed corresponding to the rotating member,
wherein when the cover is closed with respect to the base, the feeding roller abuts against the rotating member and the axle is engaged with the engaging portion, and when the driving member drives the rotating member to rotate, the axle is released from the engaging portion and the pushing portion pushes against the cover so that the cover is opened with respect to the base.

2. The printer of claim 1, further comprising an elastic member disposed between the support member and the rotating member, wherein when the driving member is triggered to drive the rotating member to rotate, the rotating member compresses the elastic member, and when the driving member is released, an elastic force generated by the elastic member repositions the rotating member.

3. The printer of claim 2, further comprising a printing head disposed on the rotating member corresponding to the feeding roller, wherein when the cover is closed with respect to the base, the elastic member causes the printing head to abut against the feeding roller.

4. The printer of claim 3, wherein the feeding roller comprises an elastic wheel body, when the cover is closed with respect to the base, the elastic wheel body of the feeding roller receive a pre-compression force caused by abutting of the printing head, and when the driving member drives the rotating member to rotate, the axle is released from the engaging portion, the pre-compression force received by the elastic wheel body is released, and the feeding roller moves toward a direction away from the printing head so that the cover is opened with respect to the base.

5. The printer of claim 1, wherein the driving member comprises a cam, a rod and a linking portion, the rod is pivotally connected to the support member, the linking portion comprises a fixed end and a free end, the cam and the fixed end of the linking portion are fixed at two opposite ends of the rod, and when the free end of the linking portion is pressed, the linking portion and the rod drives the cam to rotate so that the cam drives the rotating member to rotate.

6. The printer of claim 5, further comprising a button disposed corresponding to the free end of the linking portion, and when the button is pressed, the button drives the cam to rotate via the linking portion and the rod so that the cam drives the rotating member to rotate.

7. The printer of claim 1, wherein the driving member comprises a cam, a rod and a knob, the rod is pivotally connected to the support member, the cam and the knob are fixed at two opposite ends of the rod, and when the knob is rotated, the knob drives the cam to rotate via the rod so that the cam drives the rotating member to rotate.

8. The printer of claim 1, wherein the rotating member comprises an inclined plane facing the cover.

9. The printer of claim 8, wherein when the cover is opened with respect to the base and receives an external force to rotate toward the base, the axle of the feeding roller pushes against the inclined plane of the rotating member so that the rotating member rotates with respect to the support member, the axle engages with the engaging portion, and the rotating member abuts against the feeding roller, causing the cover to close with respect to the base.

10. The printer of claim 1, wherein the support member comprises a limiting portion, and when the cover is closed with respect to the base, the axle is engaged between the engaging portion and the limiting portion.
